(19) United States
(12) Patent Application Publication
(10) Pub. No.: US 2003/0118808 A1
(43) Pub. Date: Jun. 26, 2003

(54) Hide laminates and method of constructing the same

(76) Inventors: Jorge Canamero, Miam, FL (US); Jorge Giraldo, Granger, IN (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/295,701

(22) Filed: Nov. 15, 2002

Related U.S. Application Data
(60) Provisional application No. 60/335,725, filed on Nov. 15, 2001.
(60) Provisional application No. 60/405,628, filed on Aug. 23, 2002.

(51) Int. Cl. B32B 7/12; B32B 3/26; B32B 31/20; B32B 15/04; B32B 9/00

(52) U.S. Cl. 428/318.4; 156/308.2; 156/309.9; 428/304.4; 428/343; 428/345

(57) ABSTRACT

A method of forming an animal hide-foam laminate is disclosed comprising the steps of placing a hide layer having a treated side and an untreated side over a portion of a first surface of a substrate layer, securing the treated side of the hide layer at a first end to the substrate layer, heating a first surface of a foam layer to a melting temperature, placing the first surface of the foam layer in a facing engagement with the untreated side of the hide layer; curing the facing engagement of the foam layer and the hide layer to secure the hide layer to the foam layer. Additionally, an animal hide-foam laminate for trim applications is disclosed consisting of a foam layer having a first surface, a hide layer having a treated side and an untreated side, wherein the untreated side is in a facing engagement with the first surface, and wherein the hide layer is bonded to the foam layer by flame lamination.

### CROSS-REFERENCES TO RELATED APPLICATIONS

This application claims the benefit of U.S. Provisional Application Serial No. 60/335,725, filed on Nov. 15, 2001, entitled ANIMAL HIDE-FOAM LAMINATES AND METHOD OF CONSTRUCTING THE SAME, and Ser. No. 60/405,628, filed on Aug. 23, 2002, entitled PRESSURE SENSATIVE ADHESIVE-FOAM LAMINATES AND METHOD OF CONSTRUCTING THE SAME.

### TECHNICAL FIELD

This invention relates to methods of bonding layers of a substrate, such as animal hides or adhesives, to a foam layer to form a laminate. In particular, the method relates to flame laminating layers of a substrate to a foam layer of the type used for cushions, specifically for seating and back cushions in automotive seats.

### BACKGROUND OF THE INVENTION

Multi-layered structures and materials are commonly used in numerous industries, including the automotive, boating, furniture, and medical industries. A frequent use for multilayered structures is for automobile seat cushions and headliners, panels and dashboards where multiple layers of materials are laminated together and formed into a structure having the desired physical and aesthetic or decorative properties. For example, a cover layer such as cloth, having the desired decorative surface quality may be laminated to a substrate having desirable physical characteristics, such as strength, rigidity, hardness, softness, surface quality and the like. Additional layers may be added to vary the physical and decorative characteristics.

There are enumerable applications where an aesthetically pleasing and/or relatively expensive material is laminated to a low cost substrate. In the automotive industry, the trim application in automobile seats and headliners is illustrative of such laminated products. Typically, foamed materials, such as polyurethane or polyether are used as a base material. A facing fabric, such as nylon, is adhered to the base material to form a product. The product can be used for side panels, on doors, the back lumbar region of seats, package trays and the like.

The method of choice for bonding of the facing fabric to the base material uses flame lamination. In the conventional flame lamination manufacturing process, the layers are placed between mirror image mold surfaces, compressed, heated to cure an incorporated thermosetting resin, and then cut to shape at their periphery. Sometimes apertures for window openings, light fixtures, sun visors and the like are cut in the panels after molding. The typical headliner is in the shape of a dome with the concave surface facing downward.

Various problems exist in the assembly of the automobile seats and headliners and one of those problems is that the automobile seats and headliners include a decorative layer as the exposed surface visible to the passengers. Any folds, creases or blemishes in the visible surface create a problem for those that are marketing the vehicle. As a practical matter, it is unacceptable to have exposed blemishes.

Fabric covered foam articles, such as cushions for automotive seats, generally comprise a foam pad adhesively secured to a covering fabric. Various methods for securing fabric to foam have been described. In one method, vacuum pressure has been applied to porous contoured molds in order to draw an impervious adhesive film against a cloth fabric layer to conform the cloth fabric layer and adhesive to the contours of the inner mold surface. A matching cellular foam pad is placed in mating engagement with the adhesive film as it is held to the contour of the mold surface by vacuum pressure. The foam pad may then be compressed against the mold by a perforated platen and held in place. The vacuum may be discontinued. A heated fluid, preferably steam is supplied through the porous mold to heat and diffuse the adhesive film into the adjacent fabric layer and cellular foam pad, respectively, to adhesively secure the two together. A vacuum may then be applied to remove moisture from the fabric and foam by drawing air through the perforations in the platen and through the foam pad, fabric layer and porous mold.

Variations to this method of bonding fabric layers to cushions include methods and apparatuses for bonding fabric to seat cushion trenches in which portions of a fabric bag may be bonded to the seat cushion, and then manipulated to remove wrinkles before the rest of the fabric bag is bonded to the cushion. Another variation on the method and apparatus for adhesively bonding a fabric layer to cellular foam pad occurs where a heat sensitive adhesive is activated by microwave radiation.

For all applications in which a fabric is adhesively bonded to a cellular foam pad, and particularly for automotive seat cushions, the adhesive must securely bond the foam and fabric together. Incomplete bonding permits the foam cushion to settle and bunch and shift position relative to the fabric. This condition causes excessive wear on the fabric and on the cushion, and causes the fabric to crease or wrinkle. Creases and wrinkles not only have an unsightly appearance, but also present areas more susceptible to wear and tear.

By eliminating the use of an adhesive, a more even and complete bond may be obtained between the fabric and the foam cushion. By flame laminating the foam layer so that the upper surface melts, it is possible to then apply the fabric to the heated and melted upper surface of the foam, press the fabric to the foam to set the layers together, and then cool the layers to cure the bond between them. Such a process eliminates the need for an adhesive.

Although many fabrics have been employed in the flame lamination of a fabric layer to a foam layer, animal hide has yet to be utilized. This is primarily due to one of the fundamental characteristics of hide material in general: the shape of the hide. When animal hides are supplied as fabric material, they retain a general form of the animal from which they were obtained. As such, the animal form is not conducive to the flame lamination process. Rather, the prior art usage of animal hides in this area includes the use of surge stitches and glues to provide a means by which the hide is secured to the cushioning material. Moreover, since animal hide cannot be produced or supplied in forms sufficient to permit efficient feeding into the flame lamination process, such as in the form of a large roll or spool of hide, it has heretofore been unacceptable for such use.

Prior to the present invention, an animal hide-foam laminate and method of creating an animal hide-foam laminate, that satisfactorily solves the weaknesses associated with the more conventional methods, such as the use of surge stitches and glues, as well as the inability to prepare animal hide to foam laminates, in an efficient, practical and economically affordable manner has not been proposed or suggested by those skilled in the art.

Thus, there is a need for a animal-hide based laminate, and particularly an animal hide-foam laminate, and a method of forming a animal-hide based laminate in the form of an automotive seat cushion or other article that overcomes the aforementioned shortcomings of the prior art.

### SUMMARY OF THE INVENTION

The present invention eliminates the above-mentioned needs for an animal-hide based laminate by providing an animal hide-foam laminate and a method of forming an animal hide-foam laminate for automotive seat cushions or other articles. Additionally, the present invention eliminates the above-mentioned needs for an animal-hide based laminate by providing a pressure sensitive adhesive-hide laminate and a method of forming a pressure sensitive adhesive-hide laminate for automotive and other applications.

In accordance with the present invention, there is provided a method of forming an animal hide-foam laminate. The method includes the steps of placing a hide layer having a treated side and an untreated side over a portion of a first surface of a substrate layer, securing the treated side of the hide layer at a first end to the substrate layer, heating a first surface of a foam layer to a melting temperature, placing the first surface of the foam layer in a facing engagement with the untreated side of the hide layer, curing the facing engagement of the foam layer and the hide layer to secure the hide layer to the foam layer.

The present invention is further directed to an animal hide-foam laminate for trim applications. The animal hide-foam laminate consists of a foam layer having a first surface and a hide layer having a treated side and an untreated side. The untreated side is in a facing engagement with the first surface and the hide layer is bonded to the foam layer by flame lamination.

The present invention is additionally directed to an animal hide-foam laminate for trim applications that consists of a foam layer having a first surface and a second surface, a hide layer having a first treated side and an first untreated side, wherein the first untreated side is in a first facing engagement with the first surface, a second layer having a second treated side and an second untreated side, wherein the second untreated side is in a second facing engagement with the second surface, and wherein the hide layer is bonded to the foam layer by flame lamination and the second layer is bonded to the foam layer by flame lamination.

In accordance with the present invention, there is provided a method of forming a pressure sensitive adhesive-hide laminate. The method includes the steps of heating a first surface of a pressure sensitive adhesive layer to a melting temperature, positioning the first surface of the pressure sensitive adhesive layer in a facing engagement with an untreated side of a hide layer having a first side and a second side, and curing the facing engagement of the pressure sensitive adhesive layer and the hide layer to secure the pressure sensitive adhesive layer to the hide layer.

The present invention is further directed to pressure sensitive adhesive-hide laminate for trim applications consisting of a pressure sensitive adhesive layer having a first surface, a hide layer having an untreated side and a treated side, wherein the untreated side is in a facing engagement with the first surface of the pressure sensitive adhesive layer, and wherein the pressure sensitive adhesive layer is bonded to the hide layer by flame lamination.

The present invention is additionally directed to pressure sensitive adhesive-hide laminate for trim applications consisting of a pressure sensitive adhesive layer having a first surface and a second surface, a hide layer having an untreated side and a treated side, wherein the untreated side is in a first facing engagement with the first surface of the pressure sensitive adhesive layer, a substrate layer having a first side and an second side, wherein the second side is in a second facing engagement with the second surface of the pressure sensitive adhesive layer, and wherein the pressure sensitive adhesive layer is bonded to the hide layer by flame lamination and wherein the substrate layer is bonded to the pressure sensitive adhesive layer by flame lamination.

### BRIEF DESCRIPTION OF THE FIGURES

FIG. 1 is a cross-sectional view of the preferred animal hide-foam laminate of the present invention.

FIG. 2 is a cross-sectional view of an alternative embodiment of the present invention illustrated in FIG. 1.

FIG. 3 is a top view of the hide material layout in accordance with the preferred embodiment illustrated in FIG. 1.

FIG. 4 is a cross-sectional view of the hide material layout illustrated in FIG. 3.

FIG. 5 is a cross-sectional view of an alternative embodiment of the hide material layout illustrated in FIG. 3.

FIG. 6 is a cross-sectional view of the pressure sensitive adhesive embodiment of the present invention.

FIG. 7 is a cross-sectional view of alternative embodiment of the present invention illustrated in FIG. 6.

FIG. 8 is a side view of the flame lamination process of the present invention of FIG. 1.

FIG. 9 is a perspective view of the flame lamination process of the present invention of FIG. 8.

FIG. 10 is a side view of the flame lamination process of the alternative embodiment of the present invention illustrated in FIG. 2.

### DETAILED DESCRIPTION OF THE INVENTION

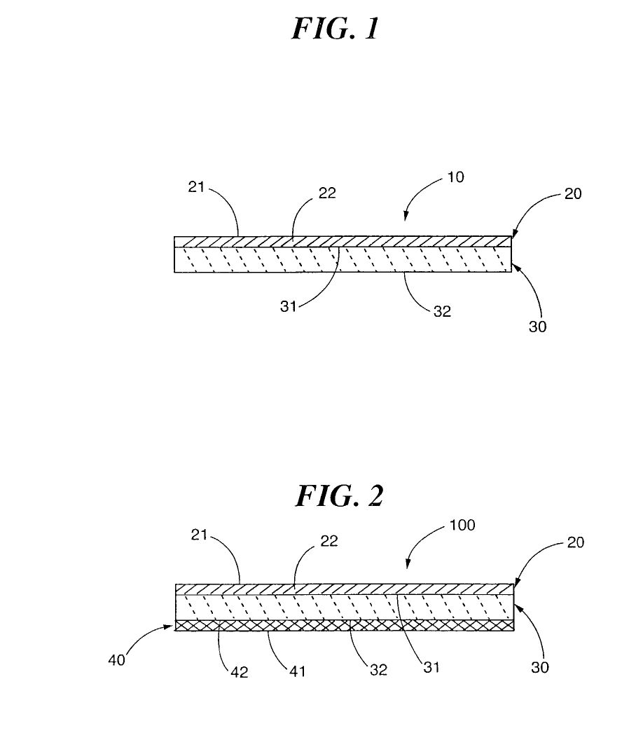

Referring now to FIG. 1, a preferred embodiment of the present invention is illustrated as the animal hide-foam laminate 10. The animal hide-foam laminate 10 generally comprises a foam layer 30 having a first surface 31 and a hide layer 20 having a treated side 21 and an untreated side 22. The untreated side 22 is in a facing engagement with first surface 31.

Hide layer 20 may be selected from any commercially available animal hide, including but not limited to cow hide, mink hide, rabbit hide, raccoon hide, alligator hide, snake hide, and the like. Hide layer 20 also includes commercially available artificial hides or hide substitutes, such as vinyl. Typically, after an animal hide or hide substitute is obtained, it is treated in a variety of manners to create the desired appearance. In commercial applications, such as in clothing or automotive seats, it is commonplace for only one side of the hide material or hide substitute to be treated. This saves cost to the manufacturer, since the consumer does not view the untreated portion of the animal hide or hide substitute.

The untreated surface or side 22 of the hide layer 20 is rough and irregular in its texture. For this reason, the untreated surface or side 22 is particularly well suited for functioning as a bonding surface. Moreover, treated surface or side 21 is the portion of the hide that is functional as, for example, a seating surface. As shown in FIGS. 1 and 2, the untreated surface or side 22 is bonded to the foam layer 30 at a first surface 31 through the process of flame-lamination, a process well known in the art, using a flame lamination machine as illustrated in FIG. 8 described below. The foam layer may be any one of a number of commercially available foams, including but not limited to polyurethane and polyether polyols.

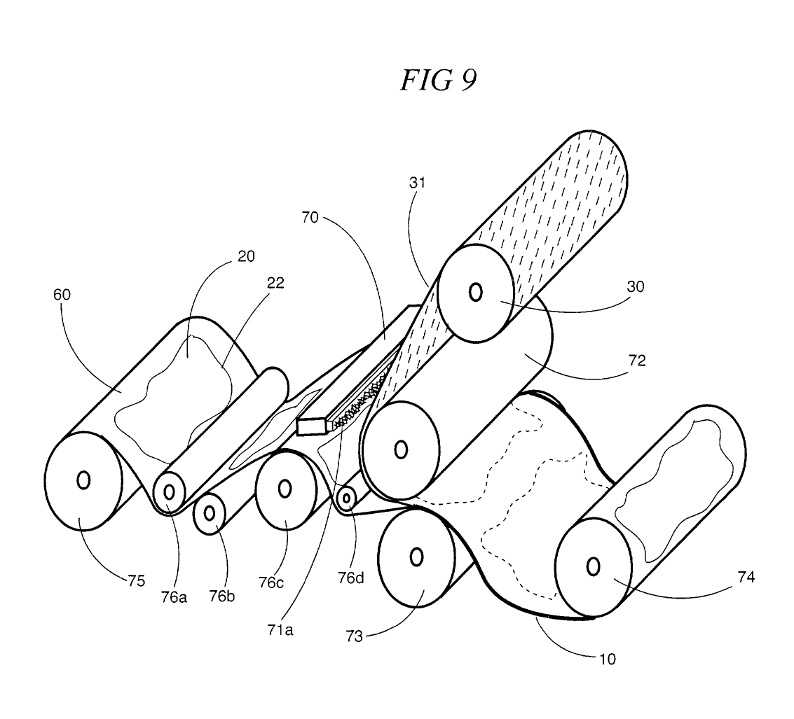

Referring now to FIGS. 8 and 9, first surface 31 of foam layer 30 is heated to a melting temperature by flames produced by heat source 70 and exiting flame port 71. The flames generated by heat source 70 can be variable by temperature. Such temperature variation of the flames is accomplished by user manipulation of the ratio of air-to-gas supplied to heat source 70. It is preferred that the distance from flame port 71 to first surface 31 be between 1/8 of an inch and an inch. Most preferably, the distance from flame port 71 to first surface 31 should be between 1/2 and 3/4 of an inch. Additionally, in order to adequately melt first surface 31 to form a bond, it is preferred that heat source 70 be tilted at an angle of between about 2 to about 7 degrees relative to the perpendicular angle between heat source 70 and first surface 31. More preferably, heat source 70 is tilted at an angle of between about 3 to about 6 degrees relative to the perpendicular angle between heat source 70 and first surface 31. Most preferably, heat source 70 is tilted at an angle of about 5 degrees relative to the perpendicular angle between heat source 70 and first surface 31.

The melting temperature generated by heat source 70 is sufficient to reduce the degree of solidity of first surface 31 to a point where it becomes substantially viscous, and is a temperature greater than 200 degrees Celsius. The viscous nature of the heated first surface 31 imbues adhesive properties to first surface 31 of foam layer 30. When the heated first surface 31 contacts untreated side 22 of hide layer 20, the viscous nature of the heated first surface 31 creates a bond with untreated side 22. Thus, foam layer 30 functions as its own adhesive to secure the hide layer 20 to foam layer 30. Heated first surface 31 contacts untreated side 22 of hide layer 20 between rollers 72 and 73, where first surface 31 and untreated side 22 are pressed together to form a bond. After being passed through rollers 76a, b, c, and/or d and pressed between rollers 72 and 73, foam layer 30 and hide layer 20 form animal hide-foam laminate 10, which can be stored on take up roll 74. It should be noted that the resulting bond between foam layer 30 and hide layer 20 cannot be re-melted or otherwise broken without the application of the melting temperature, thus permitting use of animal hide-foam laminate 10 in high ambient temperature situations, such as automotive interior trim applications.

It is preferred that rollers 72 and 73 are water-cooled in order to re-solidify the viscous, heated first surface 31, thereby facilitating a faster, stronger bond to untreated side 22. Furthermore, rollers 72 and 73 are adjustable, capable of placing variable pressures on foam layer 30 and another layer, such as hide layer 20. Varying pressures on foam layer 30 and another layer, such as hide layer 20 allows for the accommodation of various foam and substrate types that may be required by the user. Additionally, rollers 76a, b, c, and d can be conventional metal rollers.

As is illustrated in FIG. 2, a third layer 40 may be added to the animal hide-foam laminate 10 to form an animal hide-foam-third layer laminate 100. The third layer 40 may include a treated side 41 and an untreated side 42. As with the first surface 31, in this embodiment the second surface 32 is also heated to a melting temperature. This melting temperature is also sufficient to reduce the degree of solidity of the second surface 32 to a point where it becomes substantially viscous. The viscous nature of the heated second surface 32 also imbues adhesive properties to the second surface 32 of the foam layer 30. When the heated second surface 32 contacts the untreated side 42 of the third layer 40, the viscous nature of the heated second surface 32 creates a bond with the untreated side 42 as well. Thus, the foam layer 30 functions as its own adhesive to secure the third layer 40. As a result, the foam layer 30 becomes a core to animal hide-foam-third layer laminate 100.

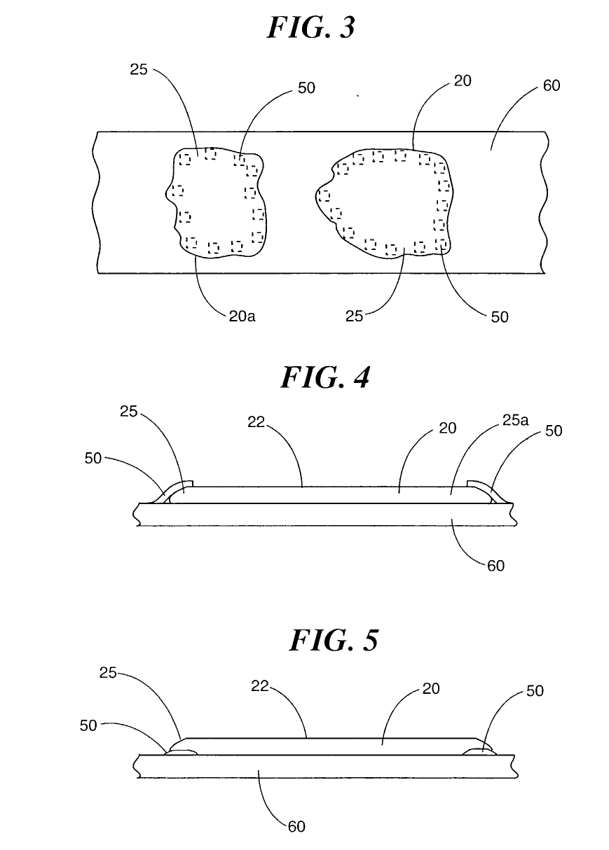

It is preferred that flame-lamination be used to apply heat to obtain a melting temperature for the first surface 31 or the second surface 32 of the foam layer 30 in the manner shown in FIGS. 8 and 9 and described above. As is illustrated in FIG. 3, the hide 20 is irregularly shaped as 20a, and may be shaped in the form of the source animal. The irregular nature of animal hide 20 and its limited surface area prevent the direct feed to a flame-lamination machine. Thus, as is shown in FIGS. 3, 4, and 5, the preferred embodiment has a first end 25 of the hide 20 that is temporarily fastened to a substrate layer 60 by temporary fasteners 50. Temporary fasteners 50 can include double-sided adhesives, single-sided adhesives, and glues. It is preferred that temporary fasteners 50 be placed along first end 25, thus permitting any slack in hide 20 to be substantially eliminated by the flame-lamination machine process (shown in FIGS. 8 and 9 and described above). First end 25 can include the leading edge and portions thereof, the perimeter and portions thereof, the trailing edge and portions thereof, of hide 20. An example of a trailing edge is illustrated as trailing edge 25a.

In practicing the method of the preferred embodiment the hide layer 20 is placed on the substrate layer 60. The treated side 21 of the hide layer 20 is placed in contact with a portion of the substrate layer 60, thereby allowing the untreated side 22 to contact the first surface 31 of the foam layer 30. The hide layer 20 is secured to the substrate layer 30 at the first end 25 of the hide layer 20. The temporary fasteners 50 temporarily secure the first end 25 to the substrate layer 60. As described above, the temporary fasteners 50 can include double-sided adhesives, single-sided adhesives, and glues. This process is repeated so that multiple hides may be positioned on a web of substrate layer 60. In one embodiment, once the hides are temporarily secured, the substrate layer is rolled up, with the hides, for use with a feed mechanism for a flame-lamination machine. In another embodiment, the temporarily secured hides 20 are then fed directly to the flame-lamination machine. The temporarily secured hides 20 may be fed through a conveyor system.

Referring again to FIGS. 8 and 9, it is preferred that roll 75 of substrate layer 60 with the temporarily secured hides is fed into the flame-lamination machine. Simultaneously, the foam layer 30 is also fed into the flame-lamination machine. The foam layer 30 comes within a user-defined, predetermined distance of the flames of the flame-lamination machine. The flames of the flame-lamination machine, factored with the variables of the distance the foam layer 30 is from the flame, the degree of heat of the flame, and the speed with which the foam layer 30 is fed, melt the first surface 31 of the foam layer 30. It is preferred that the speed at which layers are fed be between about 1 to about 70 yards/minute. More preferably, the speed at which layers are fed should be between about 20 to about 65 yards/minute. Most preferably, the speed at which layers are fed is between about 30 to about 60 yards/minute. As stated above, it is more preferred that the distance from flame port 71 to first surface 31 be between 1/2 and 1/4 of an inch. Additionally, in order to adequately melt first surface 31 to form a bond, it is preferred that heat source 70 be tilted at an angle of between about 2 to about 7 degrees relative to the perpendicular angle between heat source 70 and first surface 31. More preferably, heat source 70 is tilted at an angle of between about 3 to about 6 degrees relative to the perpendicular angle between heat source 70 and first surface 31. Most preferably, heat source 70 is tilted at an angle of about 5 degrees relative to the perpendicular angle between heat source 70 and first surface 31. The melted first layer 31 contacts the untreated surface 22 of the hide layer 20, forming a facing engagement with the untreated surface 22. The flame-lamination process results in foam additionally bonding to the portions of substrate layer 60 not covered by hide layer 20. The animal hide used in the animal hide-foam laminate 10 is many times more expensive than foam layer 30, and thus it is desirable to utilize as much of the animal hide as possible. For this reason, an excess of foam layer 30 is used to ensure that the entire animal hide 20 is covered. The excess foam is lost when the animal hide-foam laminate 10 is further processed. Although this excess foam is lost, it is inexpensive and readily available so as to not limit the commercial viability of animal hide-foam laminate 10.

The facing engagement is then cured in order to secure the hide layer 20 to the foam layer 30. Curing of the facing engagement is accomplished through the application of a curing temperature. The curing temperature is a temperature that is below the melting temperature. The curing temperature re-solidifies the melted first surface 31 of the foam layer 30, thereby securing the facing engagement between the untreated surface 22 of the hide layer 20 and the first surface 31 of the foam layer 30.

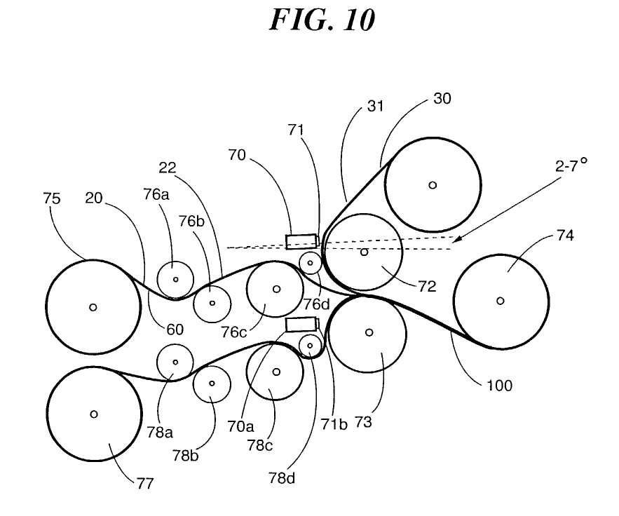

The curing temperature can be applied through a variety of conventional manners, such as through the application metal rollers 72 and 73 cooled to below the melting temperature with an internal water system, air-cooling with air having a temperature below the melting temperature, and the like. After the curing temperature is applied to the animal hide-foam laminate 10, the animal hide-foam laminate 10 may either be stored or further processed into the required shapes. The animal hide-foam laminate 10 may also be further processed by adding a third layer 40 to the second surface 32 of the foam layer 30. Utilizing the method detailed above and further shown in FIG. 10, third layer 40 is positioned by rollers 78a, b, c, and d and subsequently partially melted by heat source 70a via heat exiting flame port 71b and placed in a second facing engagement with the foam layer 30. This second facing engagement is cured as above, thus creating the three-layer animal hide-foam-third layer laminate 100. The third layer 40 can be attached to foam layer 30 simultaneously to the attachment of hide layer 20. The third layer 40 can include animal hide, vinyl, foam, insulation, or the like.

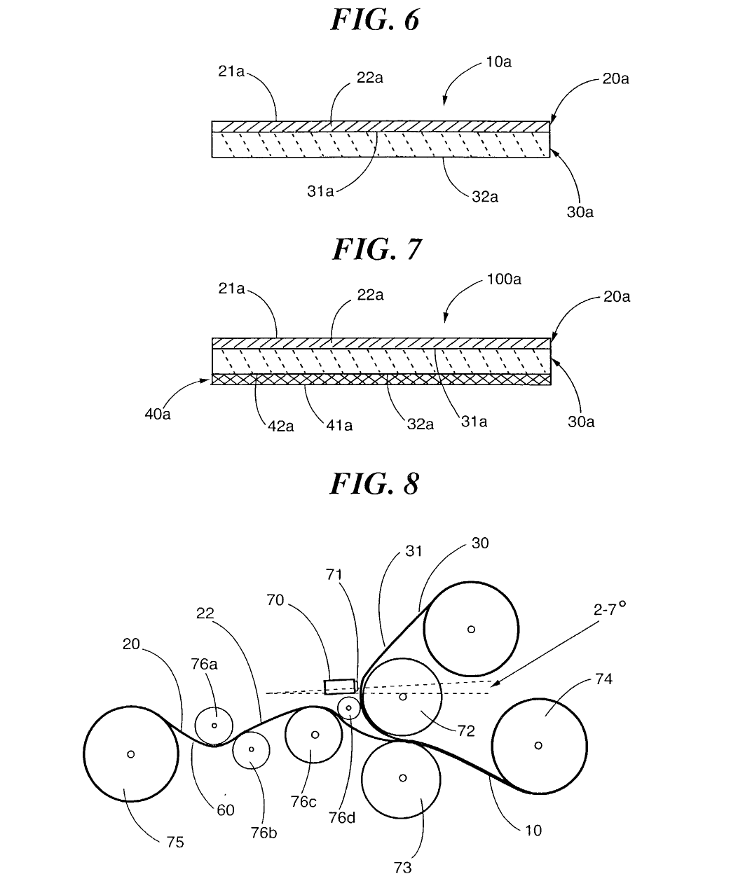

Referring now to FIG. 6, an embodiment of the present invention is illustrated as the pressure sensitive adhesive-hide laminate 10a. The pressure sensitive adhesive-hide laminate 10a generally comprises a pressure sensitive adhesive layer 30a having a first surface 31a and a hide layer 20a having a treated side 21a and an untreated side 22a. The untreated side 22a is in a facing engagement with first surface 31a.

Pressure sensitive adhesive layer 30a may be selected from any commercially available pressure sensitive adhesive.

The untreated surface or side 22a of the hide 20a is particularly suited for functioning as a bonding surface, as stated above. Moreover, second surface or side 32a is the portion of the pressure sensitive adhesive that is functional as, for example, for adhering of another (non-hide) surface. As shown in FIGS. 6 and 7, the untreated surface or side 22a is bonded to the pressure sensitive adhesive layer 30a at a first surface 31a through the process of flame-lamination, using a flame lamination machine as shown in FIG. 8 and discussed above.

The first surface 31a of pressure sensitive adhesive layer 30a is heated to a melting temperature. The melting temperature is sufficient to reduce the degree of solidity of first surface 31a to a point where it becomes substantially viscous. The viscous nature of the heated first surface 31a imbues adhesive properties to first surface 31a of pressure sensitive adhesive layer 30a. When the heated first surface 31a contacts untreated side 22a of hide layer 20a, the viscous nature of the heated first surface 31a creates a bond with untreated side 22a. Thus, pressure sensitive adhesive layer 30a functions as its own hot melt adhesive to secure the hide layer 20a to pressure sensitive adhesive layer 30a.

As is illustrated in FIG. 7, a third layer 40a may be added to the pressure sensitive adhesive-hide laminate 10a to form a hide-pressure sensitive adhesive-third layer laminate 100a. The third layer 40a may include a second side 41a and a first side 42a. As with the first surface 31a, in this embodiment either the second surface 32a or first side 42a is also heated to a melting temperature. This melting temperature is also sufficient to reduce the degree of solidity of the second surface 32a or first side 42a to a point where it becomes substantially viscous. The viscous nature of the heated second surface 32a or first side 42a also imbues adhesive properties to the second surface 32a of the pressure sensitive adhesive layer 30a or first side 42a. When the heated second surface 32a contacts the first side 42a of the third layer 40a or heated first side 42a contacts second surface 32a, the viscous nature of the heated surface or side 32a or 42a creates a bond with either the first side 42a or second surface 32a, respectively. Thus, the heated layer 30a or 40a functions as its own adhesive to secure the third layer 40a to 30a. As a result, the pressure sensitive adhesive layer 30a becomes a core to hide-pressure sensitive adhesive-third layer laminate 100a.

It is preferred that flame-lamination be used to apply heat to obtain a melting temperature for the first surface 31a or the second surface 32a of the pressure sensitive adhesive layer 30a. It is also preferred that the roll of pressure sensitive adhesive (and third layer 40a) be fed into the flame-lamination machine. The pressure sensitive adhesive layer 30a comes within a user-defined, predetermined distance of the flames of the flame-lamination machine. The flames of the flame-lamination machine, factored with the variable of the distance the pressure sensitive adhesive layer 30a is from the flame and the speed with which the pressure sensitive adhesive layer 30a is fed, melt the first surface 31a of the pressure sensitive adhesive layer 30a. The melted first layer 31a contacts the first surface 22a of the hide layer 20a, forming a facing engagement with the first surface 22a.

The facing engagement is then cured in order to secure the hide layer 20a to the pressure sensitive adhesive layer 30a. Curing of the facing engagement is accomplished through the application of a curing temperature. The curing temperature is a temperature that is below the melting temperature. The curing temperature re-solidifies the melted first surface 31a of the pressure sensitive adhesive layer 30a, thereby securing the facing engagement between the untreated surface 22a of the hide layer 20a and the first surface 31a of the pressure sensitive adhesive layer 30a.

The curing temperature can be applied through a variety of conventional manners, as detailed above, such as through the application metal rollers cooled to below the melting temperature with an internal water system, air-cooling with air having a temperature below the melting temperature, and so forth. After the curing temperature is applied to the hide-pressure sensitive adhesive laminate 10a, the hide-pressure sensitive adhesive laminate 10a may either be stored or further processed into the required shapes. The pressure sensitive adhesive-foam laminate 10a may also be further processed by adding a third layer 40a to the second surface 32a of the foam layer 30a. Utilizing the method detailed above, the second surface 32a is melted and placed in a second facing engagement with the third layer 40a, or a portion of third layer 40a can be melted instead second surface 32a. This second facing engagement is cured as above, thus creating the three-layer pressure sensitive adhesive-foam-third layer laminate 100a. The third layer 40a can be attached to pressure sensitive adhesive layer 30a simultaneously to the attachment of hide layer 20a. The third layer 40a can include pressure sensitive adhesive, hide, vinyl, foam, insulation, or the like.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A method of forming an animal hide-foam laminate, said method comprising the steps of:
placing a hide layer having a treated side and an untreated side over a portion of a first surface of a substrate layer;
securing said treated side of said hide layer at a first end to said substrate layer;
heating a first surface of a foam layer to a melting temperature;
placing said first surface of said foam layer in a facing engagement with said untreated side of said hide layer;
curing said facing engagement of said foam layer and said hide layer to secure said hide layer to said foam layer.

2. The method according to claim 1 wherein said first end is secured to said substrate layer by a temporary fastener.

3. The method according to claim 2 wherein said melting temperature is above 200° C.

4. The method according to claim 3 wherein said curing is accomplished by applying a curing temperature to said facing engagement.

5. The method according to claim 4 wherein said melting temperature is produced by a heat source at an angle of between about 2 to about 7 degrees relative to a perpendicular angle between said heat source and said first surface.

6. An animal hide-foam laminate for trim applications consisting of:
a foam layer having a first surface;
a hide layer having a treated side and an untreated side,
wherein said untreated side is in a facing engagement with said first surface; and
wherein said hide layer is bonded to said foam layer by flame lamination.

7. The animal hide-foam laminate according to claim 6 wherein said first surface is heated to a melting temperature, said melting temperature produced by a heat source at an angle of between about 2 to about 7 degrees relative to a perpendicular angle between said heat source and said first surface.

8. The animal hide-foam laminate according to claim 6 wherein said melting temperature is above 200° C.

9. The animal hide-foam laminate according to claim 8 wherein said heated first surface is placed in said facing engagement with said untreated side.

10. The animal hide-foam laminate according to claim 7 wherein said heat source is positioned between about 1/8 to 1 inch from said first surface.

11. An animal hide-foam laminate for trim applications consisting of:
a foam layer having a first surface and a second surface;
a hide layer having a first treated side and an first untreated side, wherein said first untreated side is in a first facing engagement with said first surface;
a second layer having a second treated side and an second untreated side, wherein said second untreated side is in a second facing engagement with said second surface; and
wherein said hide layer is bonded to said foam layer by flame lamination and wherein said second layer is bonded to said foam layer by flame lamination.

12. The animal hide-foam laminate according to claim 11 wherein said first surface is heated to a melting temperature, said melting temperature is produced by a heat source at an angle of between about 2 to about 7 degrees relative to a perpendicular angle between said heat source and said first surface.

13. The animal hide-foam laminate according to claim 12 wherein said melting temperature is above 200° C.

14. The animal hide-foam laminate according to claim 13 wherein said heated first surface is placed in said first facing engagement with said first untreated side.

15. The animal hide-foam laminate according to claim 11 wherein said second surface is heated to a second melting temperature, said second melting temperature produced by a heat source at an angle of between about 2 to about 7 degrees relative to a perpendicular angle between said heat source and said second surface.

16. The animal hide-foam laminate according to claim 11 wherein said heated second surface is placed in said second facing engagement with said second untreated side.

17. A method of forming a pressure sensitive adhesive-foam laminate, said method comprising the steps of:
heating a first surface of a foam layer to a melting temperature;
positioning said first surface of said foam layer in a facing engagement with a first side of a pressure sensitive adhesive layer having a first side and a second side; and
curing said facing engagement of said foam layer and said pressure sensitive adhesive layer to secure said pressure sensitive adhesive layer to said foam layer.

18. The method according to claim 17 wherein said melting temperature is above 200° C.

19. The method according to claim 17 wherein said curing includes the application of a temperature less than said melting temperature.

20. A pressure sensitive adhesive-foam laminate for trim applications consisting of:
a foam layer having a first surface;
a pressure sensitive adhesive layer having a first side and a second side, wherein said first side is in a facing engagement with said first surface of said foam layer; and
wherein said pressure sensitive adhesive layer is bonded to said foam layer by flame lamination.

21. The pressure sensitive adhesive-foam laminate according to claim 20 wherein said first surface is heated to a melting temperature, said melting temperature produced by a heat source at an angle of between about 2 to about 7 degrees relative to a perpendicular angle between said heat source and said first surface.

22. The pressure sensitive adhesive-foam laminate according to claim 20 wherein said melting temperature is above 200° C.

23. The pressure sensitive adhesive-foam laminate according to claim 22 wherein said heated first surface is placed in said facing engagement with said first side.

24. A pressure sensitive adhesive-foam laminate for trim applications consisting of:
a foam layer having a first surface and a second surface;
a pressure sensitive adhesive layer having a first side and a second side, wherein said second side is in a first facing engagement with said first surface of said foam layer;
a substrate layer having a first side and an second side, wherein said second side is in a second facing engagement with said second surface of said foam layer; and
wherein said pressure sensitive adhesive layer is bonded to said foam layer by flame lamination and wherein said substrate layer is bonded to said foam layer by flame lamination.

25. The pressure sensitive adhesive-foam laminate according to claim 24 wherein said first surface is heated to a melting temperature, said melting temperature produced by a heat source at an angle of between about 2 to about 7 degrees relative to a perpendicular angle between said heat source and said first surface.

26. The pressure sensitive adhesive-foam laminate according to claim 25 wherein said melting temperature is above 200° C.

27. The pressure sensitive adhesive-foam laminate according to claim 24 wherein said second surface is heated to a melting temperature, said melting temperature produced by a heat source at an angle of between about 2 to about 7 degrees relative to a perpendicular angle between said heat source and said second surface.

28. The pressure sensitive adhesive-foam laminate according to claim 27 wherein said melting temperature is above 200° C.
